(19) United States
(12) Patent Application Publication
(10) Pub. No.: US 2011/0083910 A1
(43) Pub. Date: Apr. 14, 2011

(54) WEIGHER/FEEDER FOR BULK MATERIAL

(76) Inventors: Michal Mikulec, Velka Dobra (CZ); Klaus Kohlmueller, Worpswede (DE)

(21) Appl. No.: 12/734,747

(22) PCT Filed: Nov. 13, 2008
(86) PCT No.: PCT/EP2008/009613

§ 371 Date: Dec. 20, 2010

(30) Foreign Application Priority Data
Nov. 20, 2007 (DE) 10 2007 055 566.2

(51) Int. Cl. G01G 11/08

(52) U.S. Cl. 177/119

(57) ABSTRACT

The invention concerns a weigh batcher for bulk material with an essentially horizontally extending conveyor (24) fastened to the outlet of a bulk material container (1, 50), at whose end away from the outlet a bulk material discharge is provided, and whose end near the outlet is situated beneath the outlet, in which a cylindrical vertical tube open on both sides (11, 13; 64) is fastened between the outlet and the end near the outlet to the upstream agitator (5, 55), and that the motor-driven conveyor (24) is mounted floating on the bulk material container.

The invention concerns a weigh batcher for bulk material with an essentially horizontally extending conveyor fastened to the outlet of a bulk material container, at whose end away from the outlet a bulk material discharge is provided, and whose end near the outlet is situated beneath the outlet.

An incinerator, in which the bulk material, for example, shredded plastic or ground household waste, is to be burned, is often connected to the end away from the outlet. To supply the incinerator, it is important to know which amount of bulk material is fed per unit time to the incinerator as secondary fuel, in order to keep possible pollution emission from it within stipulated limits. It therefore matters to measure and meter very precisely the amount of bulk material discharged from the bulk material discharge.

In the weigh batcher just mentioned, which is usually anchored to a fixed framework, fixed bearings, like cross-spring joints, are not sufficient for the required weighing accuracy. Fixed mounting of the bulk material discharge on the framework also generates incorrect measurements, among other things, because fixed mounting means that any position change of the framework, for example, by thermal fluctuations, can distort the measurement. Finally, loading of the conveyor with bulk material from the bulk material container is subject to fluctuations, because the material filled into the bulk material container forms a sidewall angle, especially during incomplete filling, which leads to irregular release of bulk material per unit time from the bulk material container.

The mentioned difficulties are overcome according to the invention in the weigh batcher just mentioned, if a cylindrical vertical tube open on both sides is fastened to the upstream agitator between the outlet and the end near the outlet and the motor-driven conveyor is mounted floating on a fixed framework. In contrast to the bulk material conveyor, which is often shaped conically, especially in the lower part, the tube, in cooperation with the agitator, prevents formation of sidewall angles in the bulk material, so that the conveyor is loaded with a uniform material stream. Floating support of the conveyor, which can be a revolving endless belt or feed screw, balances out thermal or other changes in the framework without a problem, so that an accuracy of bulk material measurement of 1-2% of a stipulated target amount is attainable with the weigh batcher according to the invention.

If the tube is fastened eccentrically to the bottom of the bulk material container in a modification of the invention, the agitator can be driven by a shaft that extends centrally and vertically into the bulk material container. The agitator can have an agitator blade connected to the shaft as circulating agitator, which continuously mixes the bulk material and feeds it to the tube via the outlet. In an alternative variant, the shaft extends horizontally into the bulk material container, the tube being fastened centrally on the bottom of the bulk material container. The agitator, in this case, can be designed as a pendulum agitator, in which a bent agitator fastened to the horizontal shaft sweeps back and forth over the opening of the tube in the bulk material container. The bulk material container itself can be designed resistant to water surges up to about 10 bar by corresponding reinforcement, for example, in order to be able to accept sewage sludge.

A particularly preferred variant of the invention proposes that the conveyor be mounted on the framework via self-aligning bearings. It is recommended for this purpose to support the conveyor on the end near the outlet via a first self-aligning bearing, which records bulk material loading of the conveyor, and on the end away from the outlet via at least a second self-aligning bearing on the framework. This type of self-aligning bearing is expediently designed, so that it has a load cell, whose force-introducing part is coupled to a punch via a first spherical surface, the opposite end of the punch being coupled via a second spherical surface to the framework. Load cells are known, per se, for example, from documents DE 11 29 317 A1 or DE 39 24 629 C2 or DE 37 36 154 C2. A load cell converts a force applied to its force-introducing part to an electrical signal, which is processed in an evaluation circuit.

In an expedient embodiment, the weigh batcher according to the invention is equipped with a control, according to which the drive motor of the conveyor and the second self-aligning bearing are electrically connected to a first control circuit, so that a control signal for the drive motor is produced from a comparison of the stipulated target value with a product from the actual conveyor loading with bulk material and the actual speed of the drive motor. The control can also expediently ensure that a stipulated base speed of the agitator blade is modified by a correction signal, when the discharge weight lies outside of a stipulated range. The actual speed of the agitator blade can therefore be raised by the correction signal above the base speed, when the discharge weight lies below the range and vice versa. A speed of the agitator blade is therefore set, which keeps the discharge weight within the stipulated range for a specified conveyor path and a specified bulk density.

Finally, it has proven expedient for monitoring of continuous feed measurement, if the measured feed amount is compared in a control counter with the actual weight reduction in the bulk material container and the control correspondingly adjusted during deviations. For this purpose, a control counter can be used to compare the weight reduction of the bulk material container with the measured feed amount of discharged bulk material and indicate deviations.

Small loads of the conveyor can be recorded with the mentioned accuracy with the invention.

For preferred variants of the invention, the dependent claims are also referred to. The invention is explained in detail below on a practical example depicted in the appended drawing. In the drawing:

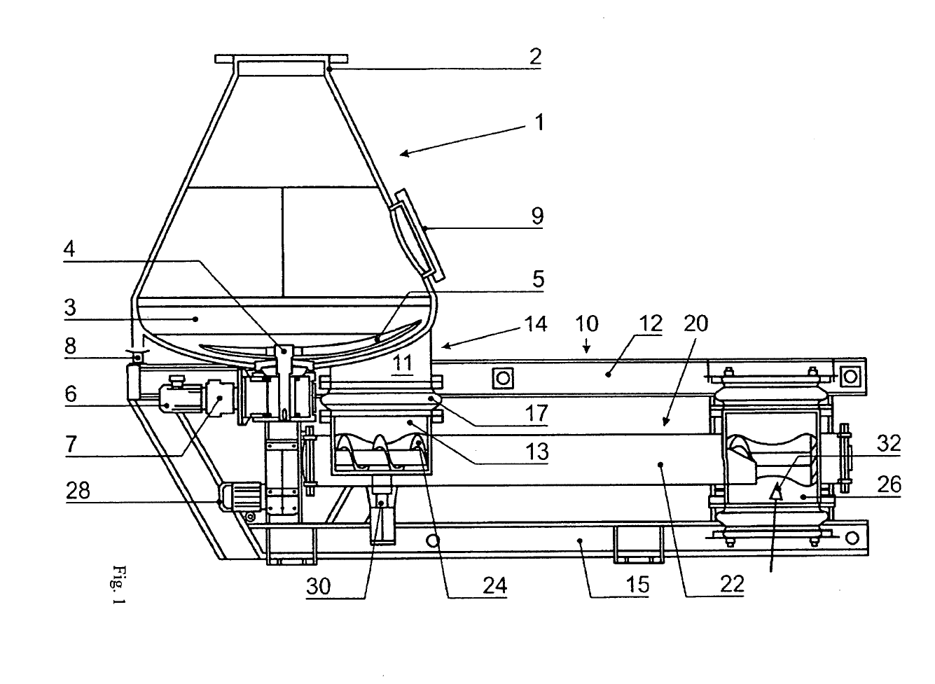

FIG. 1: shows a schematic view of a weigh batcher equipped with the features of the invention, partially in a side view,

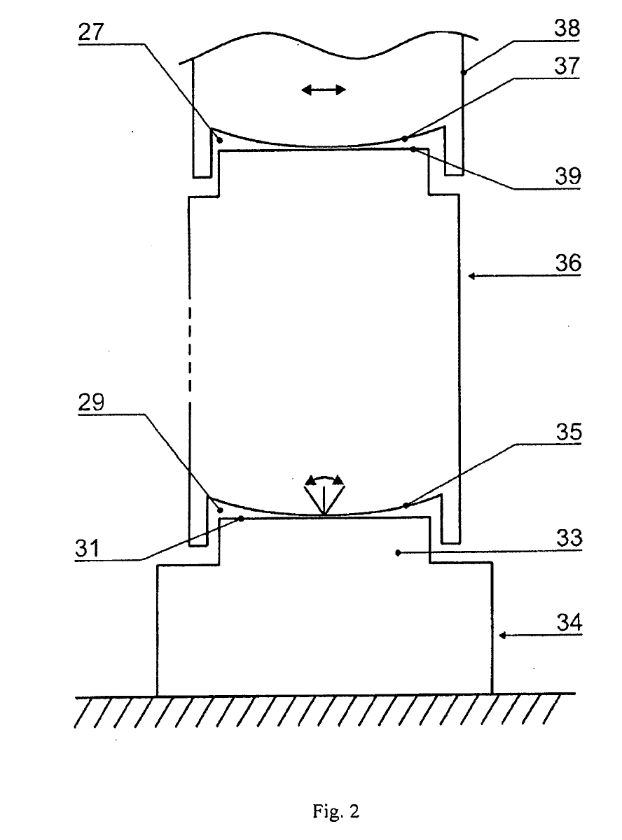

FIG. 2 shows a schematic sketch of a self-aligning bearing, used in the weigh batcher according to FIG. 1,

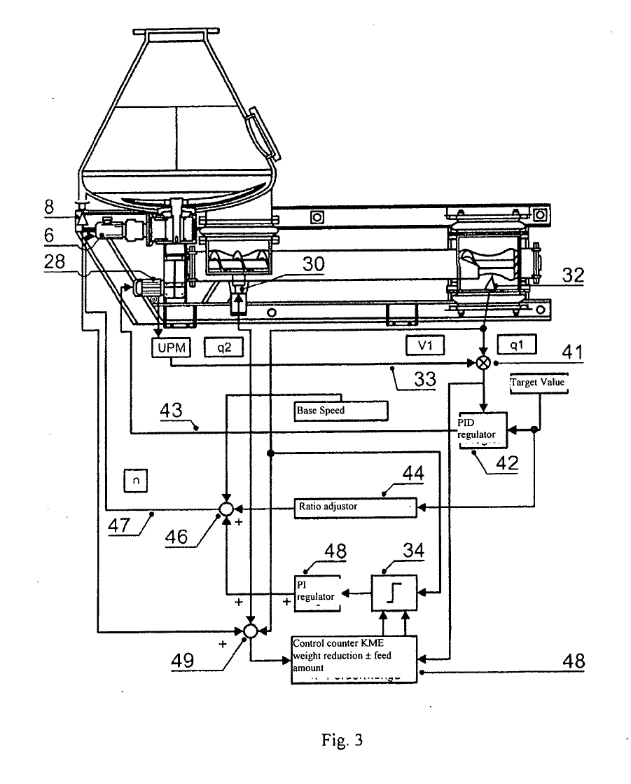

FIG. 3 shows a schematic view of the weigh batcher according to FIG. 1 with the corresponding control,

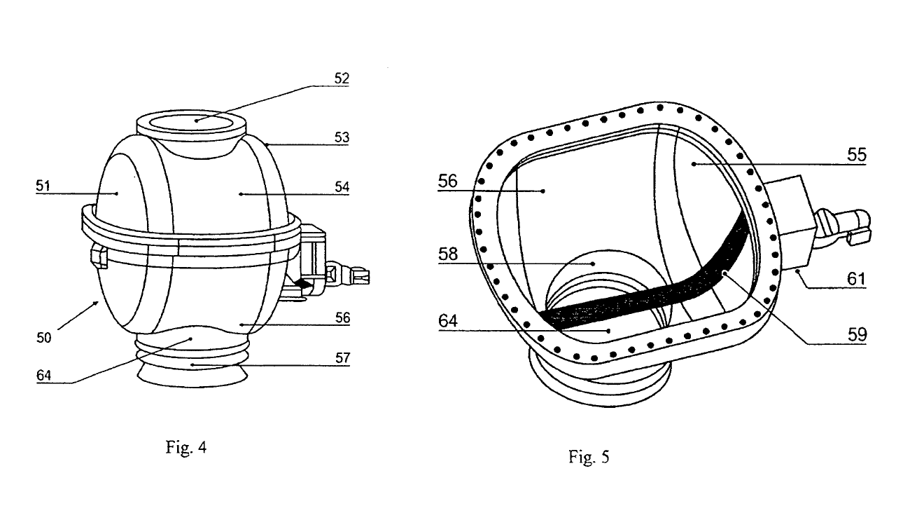

FIG. 4 shows a bulk material container for the weigh batcher according to FIG. 1 in a schematic perspective view.

FIG. 5 shows a schematic perspective view of the lower part of the bulk material container according to FIG. 4 from above.

A pear-shaped bulk material container 1, which has a downward widening truncated cone shape with an upper filling opening 2 for bulk material and a lower circular trough-like bottom 3, is fastened on the upper beam 12 of a roughly trapezoidal frame 10 in side view, made of steel supports. The bulk material container rests on the beam 12, as well as at least one additional parallel beam (not shown) of the frame 10 via at least three self-aligning bearings, spaced in the peripheral direction, one of which is apparent in FIG. 1 and designated 8. An inspection cover 9 is used for visual inspection of the bulk material container interior.

A shaft 4 passes centrally through bottom 3, on which an agitator blade 5 is splined within bottom 3. When shaft 4 is rotating, the agitator blade rotates just above bottom 3 through the bulk material introduced to the bulk material container, loosens and distributes it uniformly over bottom 3 and uniformly fills a tube, designated 14. A drive motor 6 is fastened to the bulk material container 1 beneath the bulk material container 1, whose output shaft is coupled to shaft 4 via a gear mechanism 7.

The cylindrical tube 14 is fastened vertically to bottom 3 off-center, its axis extends vertically and its upper end opens through an outlet, not shown in detail, into the interior of the bottom 3 and therefore into the bulk material container 1. The tube 14 has an upper tube connector 11 and a lower tube connector 13, which are connected to each other coaxially via a flexible sleeve 17, and both have the same free width. The upper tube connector 11 is fastened to bottom 3 and the lower tube connector 13 is fastened to weigh batcher 20.

The weigh batcher 20 has an elongated, fixed protective tube 22, in whose interior a feed screw 24 is mounted to rotate. On the front end of protective tube 22 near the outlet, the lower tube connector 13 is fastened, which opens into the interior of the protective tube 22 through a corresponding opening in it with roughly the same free width as the tube connector 13. The protective tube 22 rests roughly in the center relative to the opening of the tube connector 13 via a first self-aligning bearing 30 on a lower beam 15 of frame 10. The protective tube rests at the end away from the outlet via a second self-aligning bearing 32, which is only shown by a hollow arrow, also on the lower beam 15 of frame 10. On the end away from the outlet, the protective tube 22 also has a lower opening, which discharges into a discharge tube 26. The discharge tube 26 has roughly the same free width as the lower opening of tube 14. The second self-aligning bearing 32 can consist of two self-aligning bearings in a practical variant, one of which is arranged on one side of the discharge tube 26 and the other on the opposite side of discharge tube 26.

A drive motor 28 for the feed screw 24 is arranged in space-saving fashion beneath gear mechanism 7.

According to FIG. 2, each of the mentioned self-aligning bearings consists of a load cell 34 and a punch 36. A flat surface 31 of the force-introducing part 33 of the load cell 34 is in contact with a convexly configured end surface 35 of punch 36. A convex surface 37 of a component 38 that moves across the axis of cylindrical punch 36, for example, of frame 10, is in contact with a flat end surface 39 of punch 36, in which the end surfaces 35 and 39 are opposite each other. If the component 38 is moved back and forth across the axis of the load cell 34 by a few millimeters, the vertical force transfer from component 38 to load cell 34 remains unaffected. Despite these possible movements, the punch 36 remains trapped both in the recess 27 provided on component 38 around surface 37 and around the raised force-introducing part 33 of the load cell 34, because of a recess 29 of punch 36 formed on the lower end surface 35. Naturally, the convex surfaces can also be provided only on the opposite end surfaces of the punch, in which case the opposite surfaces 31 and 37 are configured flat.

To obtain reliable measured values concerning the feed amount of bulk material, an electrical control device is used, which is shown in the lower half of FIG. 3 and includes a first control circuit for screw speed, a second control circuit for speed of the agitator blade 5 and a balancing circuit. A multiplier 41 belongs to the first control circuit, which receives on the input side an output signal from the second self-aligning bearing 32 and an output signal representing the actual rotational speed of the conveyor screw via signal line 33 from the screw drive motor 28 and feeds the product of the two output signals to a PID regulator 42 on the output side. The PID regulator 42 compares the product with a stipulated target value for screw speed. Via the output line 43 from the PID regulator 42, a control signal is fed to a control input of the screw drive motor 28, which represents the comparison result. If the product is smaller than the target value, the feed amount of bulk material, which is represented as the product of screw speed in m/s and screw load in kg/m, is too small, the control signal causes an increase in screw speed and vice versa.

The second control circuit includes an adjustable ratio adjuster 44, which feeds a certain percentage of the target value to a difference former 46 from the target value received on the input side on the output side. Via an additional input, the difference former 46 receives a signal representing the base speed of the agitator blade 5 and at a third input the difference former 46 receives an output signal from a PI regulator 48, which is roughly proportional to the discharged bulk material within a range of discharged bulk material recorded by the second self-aligning bearing 32 within a range defined by an upper limit value and a lower limit value. For this purpose, a limit value transducer 34 is connected in front of the PI regulator 48, which activates the PI regulator 48 only within the mentioned range. The output signal from the difference former 46 serves as control signal on line 47 for drive motor 6 of the agitator blade 5. The regulator 48 ensures that during a fluctuating bulk material discharge weight, the speed of the agitator blade 5 is increased or reduced as a function of the measured load of the conveyor with bulk material. Consequently, at each point, a homogeneous material flow into the entry area of the conveyor is guaranteed, even in particularly difficult bulk materials, like fluff (especially waste).

The balancing circuit essentially contains a control counter 48, which compares the weight reduction of bulk material in the bulk material container 1 with the measured feed amount of discharged bulk material and indicates deviation, so that the control device can be compensated. For this purpose, the control counter receives at a first input, the product signal from the product former 41 and at a second input, a sum signal, which is formed in an adder 49 from the output signal of the self-aligning bearing 8, the output signal from the first self-aligning bearing 30 and the output signal from the second self-aligning bearing 32 by summation.

The invention permits several variants, each of which operates according to the principle just explained. For example, the first self-aligning bearing 30 need not be directly supported on frame 10. Instead, there is also the possibility of fastening the first self-aligning bearing 30 to the bulk material container 1 via its force diversion part. The invention is also not restricted to the use of a pear-shaped bulk material container, like the bulk material container 1. FIGS. 4 and 5 show a variant of a bulk material container 50, which has the advantage of particularly simple production. The bulk material container 50 has essentially the shape of a lying cylinder with rounded opposite ends 51, 53 and is assembled from two semi-cylindrical half-shells 54, 56 bolted to each other. The bulk material filling opening 52 is provided in the upper half-shell and the lower half-shell 56 has a central bulk material outlet 58, to which a tube 64 corresponding to tube 14 is fastened centrally with a flexible sleeve 57. In the interior of the lower half-shell 56, a bent pivot bracket 55 is situated, which is fastened to a shaft 59 extending horizontally through one of the ends of the lower half-shell 56. A drive motor 61 for shaft 59 is laid out, so that the pivot bracket 55 can execute back-and-forth pivoting movement right above the bottom of the lower half-shell.

The bulk material container 50 has the additional advantage that it can withstand a pressure surge load of up to about 10 bar, as can occur during treatment of sludge and similar materials, without hazard, for example, by mounting an external reinforcement (not shown). The bulk material container 1 can also be provided with external reinforcement to ensure resistance to pressure surges. It is also possible to configure the bulk material container horizontally elongated, trough-shaped or cylindrically upright with a flat bottom.

1. Weigh batcher for bulk material with an essentially horizontally extending conveyor (24) fastened to the outlet of a bulk material container (1, 50), at whose end away from the outlet a bulk material discharge is provided, and whose end near the outlet is situated beneath the outlet, characterized by the fact that the conveyor (24) is a motor-driven feed screw, which is supported via first (30) and second self-aligning bearings (32) on a frame, in which each of the self-aligning bearings (30, 32) has a load cell (34), and that a cylindrical vertical tube open on both sides (11, 13; 64) is fastened between the outlet and the end near the outlet to the upstream agitator (5, 55), and that the conveyor (24) is mounted floating on the bulk material container.

2. Batcher according to claim 1, the bulk material container is mounted via third self-aligning bearings (8) on the fixed frame (10).

3. Batcher according to claim 2, characterized by the fact that the third self-aligning bearings (8) have a load cell (34).

4. Batcher according to claim 1, characterized by the fact that the tube (11, 13) is fastened eccentrically on the bottom (3) of the bulk material container (1).

5. Batcher according to claim 3, characterized by the fact that the conveyor is mounted on the end near the outlet via a first self-aligning bearing (30) and on the end away from the outlet via at least a second self-aligning bearing (32).

6. Batcher according to claim 1, characterized by the fact that the force-introducing part (33) of the self-aligning bearing (8, 30, 32) is coupled to a punch (36) via a first spherical surface (35), and in which the opposite end of the punch (36) is coupled to the frame via a second spherical surface (39).

7. Batcher according to claim 1, characterized by the fact that the drive motor (28) of conveyor (24) and the second self-aligning bearing (32) are connected electrically to a first control circuit, so that a control signal for the drive motor (28) is obtained from a comparison of a stipulated target value with a product from the actual conveyor load with bulk material and the actual speed of the drive motor.

8. Batcher according to claim 1, characterized by the fact that the bulk material container (1, 50) is equipped with an agitator driven via a shaft (4, 59), whose agitator blade (5, 55) sweeps right over the outlet (58), and that the speed of the agitator blade (5, 55) is controlled by a signal derived from a comparison of a stipulated base speed with the difference from a stipulated percentage of the target value and the bulk material load of the conveyor (24) at its end near the outlet.

9. Batcher according to claim 7, characterized by the fact that the bulk material load of the conveyor at its end near the outlet is recorded by the first self-aligning bearing (30) and the bulk material discharge by conveyor (24) at the second self-aligning bearing (32), as well as the load of the bulk material container, are recorded on an additional self-aligning bearing (8) and summed, and the sum signal, as well as the product signal, fed to a control counter (48), which compares the weight reduction to the feed amount.

10. Batcher according to claim 1, characterized by the fact that a vertical shaft (4) extends centrally into the pear-shaped bulk material container (1) to drive the agitator blade.

11. Batcher according to claim 1, characterized by the fact that a shaft (59) to drive a pivot bracket (55) extends horizontally into the barrel-shaped bulk material container (50).

12. Batcher according to claim 1, characterized by the fact that the bulk material container (1, 50) is provided with external reinforcement.
